(19) United States
(12) Patent Application Publication
(10) Pub. No.: US 2007/0067488 A1
(43) Pub. Date: Mar. 22, 2007

(54) System and method for transferring data

(75) Inventors: Michael Sean McIntire, Sacramento, CA (US); Subash Ramanathan, Marina Del Rey, CA (US)

Correspondence Address: SCHWEGMAN, LUNDBERG, WOESSNER & KLUTH/EBAY, P.O. BOX 2938, MINNEAPOLIS, MN, 55402, US

(73) Assignee: eBay Inc.

(21) Appl. No.: 11/229,255

(22) Filed: Sep. 16, 2005

(51) Int. Cl. G06F 15/173

(52) U.S. Cl. 709/238

(57) ABSTRACT

A system and computer-implemented method transfers data from a source system to a target system. In an embodiment, a control process instantiates and communicates with one or more source nodes and target processes on one or more nodes. After successfully instantiating the source and target processes, the control server informs the source process to transfer data to the target process. In an embodiment, the control server instantiates a multitude of server node and target node, and the transfer of data occurs simultaneously in parallel.

### TECHNICAL FIELD

Various embodiments relate generally to the field of data transfer, and in an embodiment, but not by way of limitation, to a system and method involving a control process to direct and oversee the transfer of data from a source system to a target system.

### BACKGROUND

Over the past several decades, there has been an explosion of information available on virtually any subject. A major reason for this explosion has been the advent of and the subsequent ubiquity of computers and networks. This information explosion has particularly impacted large or moderately sized business entities. Quite often, for reasons such as backups or disaster recovery, data stored within a business organization has to be transferred from one system (source) to another system (target). In the information processing profession, transformation from one database management system to another is referred to as extraction, transfer, and loading (ETL) operations. Such ETL functions however can occupy a great deal of resources on both the source and target systems (such as processor time and bandwidth) and network resources—resources that could be better used for other information processing needs.

FIG. 1 illustrates a typical system 100 for transferring data from a source system 110 to a target system 150 and a target system 170. In such a system 100, a process or processes 115 acquire data from the source site database 120. The process 115 loads the data, performs any necessary transformation on the data, and temporarily lands or stores that data on the source system 110. The source system 110 can push the data into database 170. A file utility 130 transfers the data from the source system 110 to the target system 150. A process or processes 155 on the target system 150 receives the data into storage, performs any necessary transformation on the data, and loads the data into the appropriate database 160 on the target system. The system of FIG. 1 is commonly referred to as a dual loading system. Another typical loading method is to have a process such as 115 load both databases 160, 170 either sequentially or simultaneously.

There are some drawbacks however to systems like the one illustrated in FIG. 1. In general, such systems take up an inordinate amount of system resources such as processor time and system bandwidth. Additionally, data transfers with such systems can take an excessive amount of time to execute and complete. It is furthermore a lengthy, costly, and risky endeavor to move from loading a single database management image into a source system to loading two database management system images. What is therefore needed in the art is a more efficient system and method to transfer data from one processing system to another processing system, especially in systems that utilize a dual loading technology.

### SUMMARY

Various embodiments of the invention relate to a system that transfers data from a source system to a target system. In an embodiment, one or more control processes create one or more modules on a source system that will transfer data and one or more modules on a target system that will receive data. The control process communicates with the source modules and target modules. After the control process has successfully brought up the source and target processes, the control process informs the source and target modules to communicate with each other, and to begin the transfer of data. In embodiments in which the control process instantiates multiple source modules and target modules, a massively parallel processing system is created between the source system and the target system.

### BRIEF DESCRIPTION OF THE DRAWINGS

FIG. 1 is an example of a prior art system that may be used in connection with the transfer of data from a source system to a target system.

FIGS. 2a, 2b and 2c illustrate an example embodiment of a system architecture that may be used in connection with transferring data from a source system to a target system.

FIG. 3 is an illustration of a process to transfer data from a source system to a target system divided up into phases of the transfer process.

FIG. 4 is an example embodiment of a control queue that may be used in connection with an embodiment of the invention.

FIG. 5 is an example embodiment of a source queue that may be used in connection with an embodiment of the invention.

FIG. 6 is an example embodiment of a target queue that may be used in connection with an embodiment of the invention.

FIG. 7 is an example embodiment of a computer system upon which an embodiment of the invention may execute.

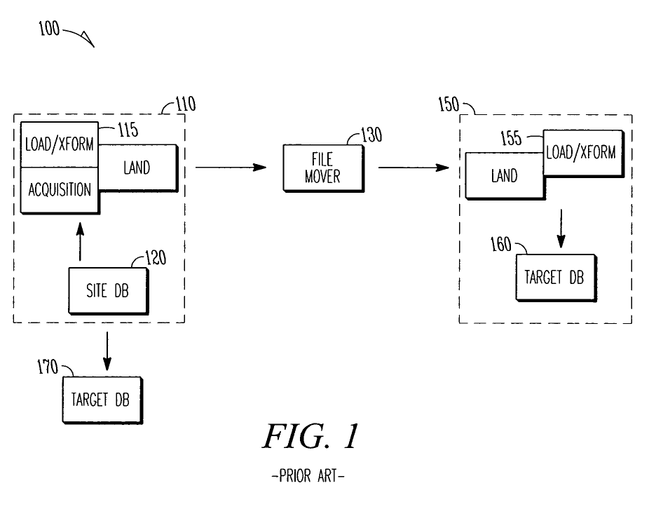

### DETAILED DESCRIPTION

One or more embodiments of a system and method for transferring data from a source system to a target system are described. In the following description, for purposes of explanation, numerous specific details are set forth in order to provide a thorough understanding of the present invention. It will be evident, however, to one skilled in the art that the present invention may be practiced without these specific details.

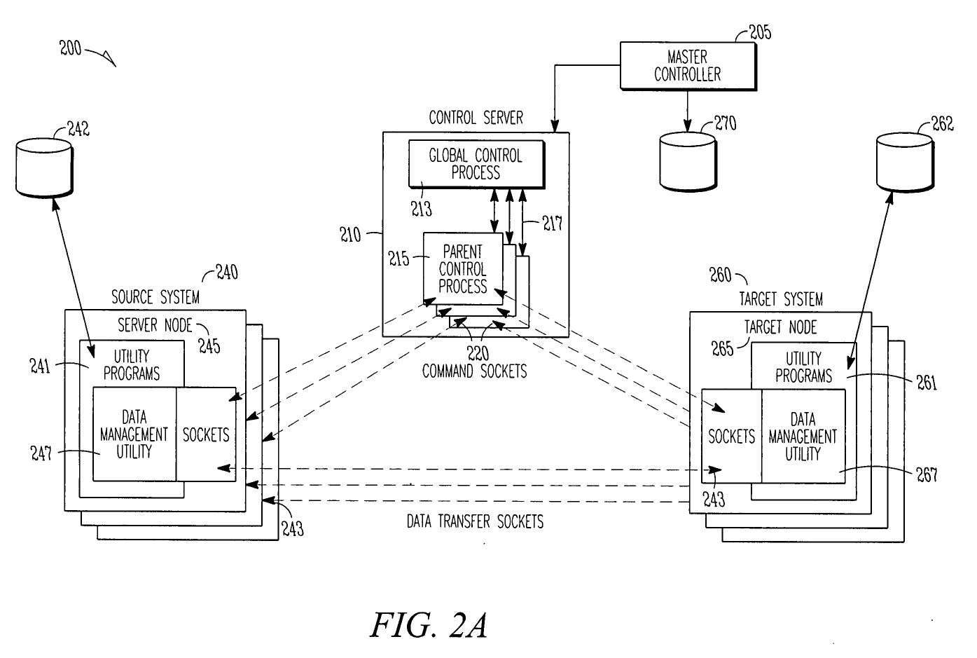

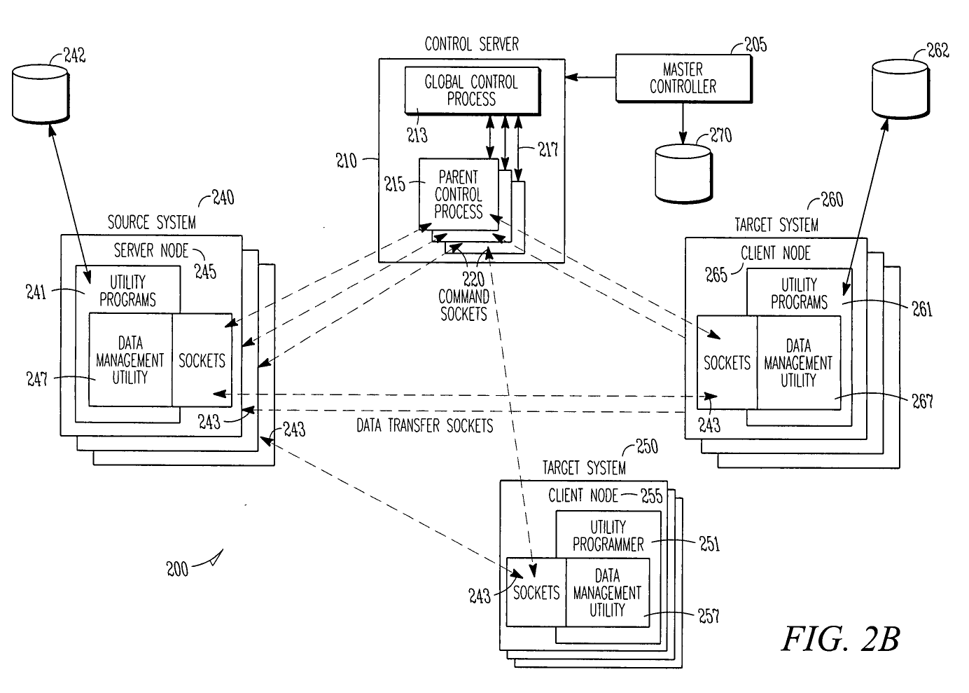

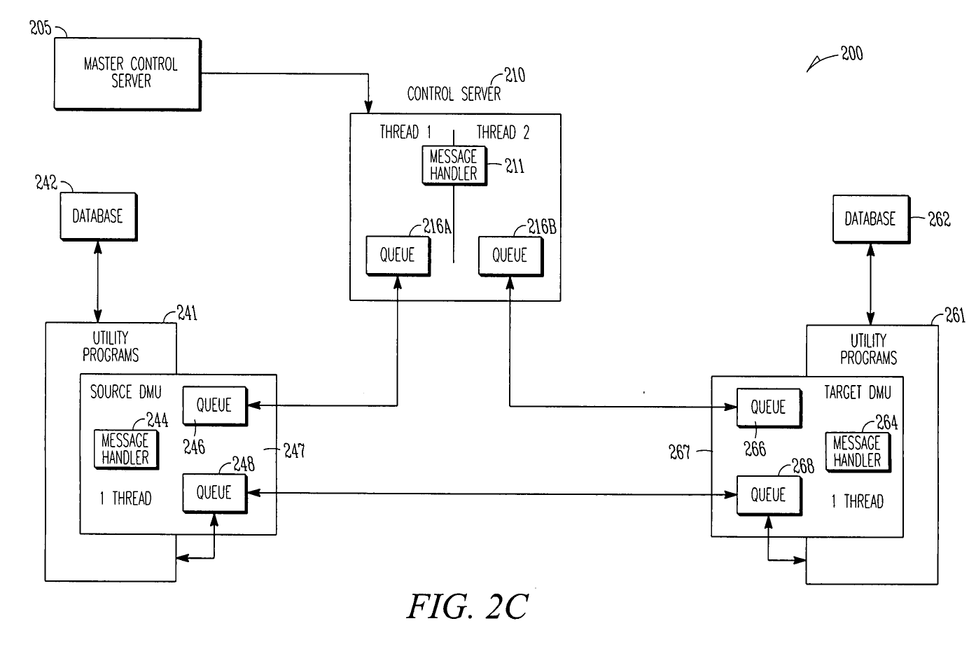

FIG. 2a illustrates an embodiment of an architecture that may be employed to transfer data from a source system to a target system. The architecture 200 includes a master control server 205 and a control server 210. The control server 210 includes at least a global control process 213, and a parent control process 215. The global control process 213 communicates with one or more parent control processes 215 through communication paths 217. Each parent control process 215 is associated with a command socket 220, through which it communicates with a source system 240 and a target system 260. In an embodiment, the communication to source system 240 is through the command socket 220 and a source data management utility (DMU) 247, and the communication to the target system 260 is through the command socket 220 and a target data management utility (DMU) 267. The source system 240 may include one or more source server nodes 245, and the target system may include one or more target nodes 265. These multiple source nodes and target nodes may operate on multiple images of the operating system, and as such, provide a massively parallel processing system to transfer data from the source system 240 to the target system 260. Each source node 245 includes one or more of the source data management utility programs 247. Each target node 265 includes one or more of the target data management utility programs 267. A data transfer socket 243 facilitates communication between a node 245 on the source system 240 and a node 265 on the target system 260. In an embodiment, a node is a single operating system with a dedicated processor and storage resources.

FIG. 2b illustrates another embodiment of an architecture that may be used to transfer data from a source system to a target system. The system 200 of FIG. 2b includes all the components of the system of FIG. 2a, and further includes a second target system 250. In the system of FIG. 2b, the source system 240 transfers data to the target system 250 and data to the target system 260. The data that is transferred to the two target systems 250, 260 may be the same data, may be completely different data, or there may be an overlap of the data transferred to the two systems. In the embodiment of FIG. 2b, two of the three nodes of the source system 240 communicate with two nodes of the target system 260, and one of the three nodes of the source system 240 communicates with one node of the target system 250.

FIG. 2c illustrates another embodiment of a data transfer system 200. In FIG. 2c, certain components and aspects of FIGS. 2a, 2b are not illustrated so as to emphasize other features of such a system 200. Specifically, FIG. 2c illustrates that in an embodiment the control server 210 communicates with the source DMU 247 and the target DMU 267 through queues 216a, 216b and queues 246 and 266. FIG. 2c further shows that a source DMU 247 communicates with a target DMU 267 through a queue 248 and a queue 268. The communication between the control server 210 and the source DMU 247 is handled by control server message handler 211 and source message handler 244. Similarly, the communication between the control server 210 and the target DMU 267 is handled by the control server message handler 211 and target message handler 264. In the embodiment of FIG. 2c, the two queues 216a and 216b of the control server 210 are multi-threaded, and the queues 246, 266 of the source and target DMUs 247, 267 respectively are single threaded. The multi-threaded architecture of queues 216a and 216b of the control server 210 allows the control server 210 to communicate with the source DMU 247 independently of the target DMU 267 and vice versa. FIG. 2c further illustrates that a single threaded source queue 248 and a single threaded target queue 268 communicate with utility programs 241 and 261, and databases 242 and 262 respectively. It is noted that FIGS. 2a, 2b and 2c are but three examples of embodiments of the invention, and that other such embodiments with multiple source nodes 245 communicating with multiple target nodes 265, thereby implementing a massively parallel processing architecture, are within the scope of the invention. For purposes of ease of illustration, explanation, and understanding, the embodiment of FIG. 2a will be used in connection with further descriptions of the invention.

In an embodiment, the master control server 205 reads the global processing file 270. The global processing file 270 includes parameters that define the environment in which a system such as the system 200 in FIG. 2a will be created. In an embodiment, the global processing file may be a unitary file. In another embodiment, the global processing file may be implemented across several distinct files. The global processing file 270 may include the location of the control server 210. This location may be a web site, it may be the location of code to be executed or interpreted to bring up the source and target systems, or it may be the location that such code executes after compilation/interpretation. Similarly, the global processing file 270 may include the physical location of the source system 240 and the target system 260. This location may be a web site, it may be the location of code to be executed or interpreted to bring up the source and target systems, or it may be the location that such code executes after compilation/interpretation. Upon reading the global processing file 270, the master control server 205 instantiates the control server 210.

The global processing file 270 further may include a parameter indicating the number of parent control processes 215 to instantiate. After the parent control processes 215 are instantiated, the control server 210 reads the global processing file 270 to determine the number and identity of source DMUs 247 and target DMUs 267, and the location of the source nodes 245 and target nodes 265 on which these DMU modules execute. In an embodiment, this is implemented in a script that contains a logon id and a password for each particular source node 245 and target node 265, which allows the control server 210 to access the particular source and target systems. Such a script may also include the locations of the files that will be transferred to the target node 265 by the particular source node 245 that is being logged onto. In an embodiment, this transfer may involve the complete transfer of a file or a number of files. In another embodiment, this transfer may only involve the records in a file that have been changed since the last transfer of data from the source node 245 to the target node 265. The logic to control such a determination may be in the source DMU 247, the source utility program 241, or other processes, files, or scripts within the system.

When instantiating the source and target nodes 245, 265, the control server 210 further uses the global processing file 270 to determine the sockets through which the instances of the source DMU 247 will communicate with the paired instances of the target DMU 267. The control server 210 may further determine a checkpoint and a checksum from the global processing file 270.

The global processing file 270 may further include a parameter to indicate the bandwidth that the system 200 is permitted to consume during a transfer. For example, if the total bandwidth available between the source system and target system is 100 Mbs, a parameter in the global processing file 270 may indicate that only 25 Mbs of bandwidth are to be consumed by the transfer process - - - leaving the remainder of the bandwidth for other processing/communication needs. Consequently, in an embodiment, a source node 245 and target node 265 will monitor themselves to assure that they stay within the confines of their allotted bandwidth. If they are approaching or exceeding their allotted bandwidth, the DMU processes 247, 267 may pause themselves for a period of time, thereby freeing up network resources for other processes.

The use of a global processing file 270 to persist and allocate resources in the system 200 is a form of statically persisting and allocating such resources. Any other method that allows an operator to statically persist and allocate resources would also work in lieu of the global processing file 270. In another embodiment, the system 200 dynamically persists and allocates resources. As an example embodiment of such a dynamic system, a service process is invoked which waits for instructions. The instructions may consist of the specification of the available resources, and the service will then determine how to use these resources based on load and availability. The service process can then determine at runtime the number of source and control processes that should be instantiated.

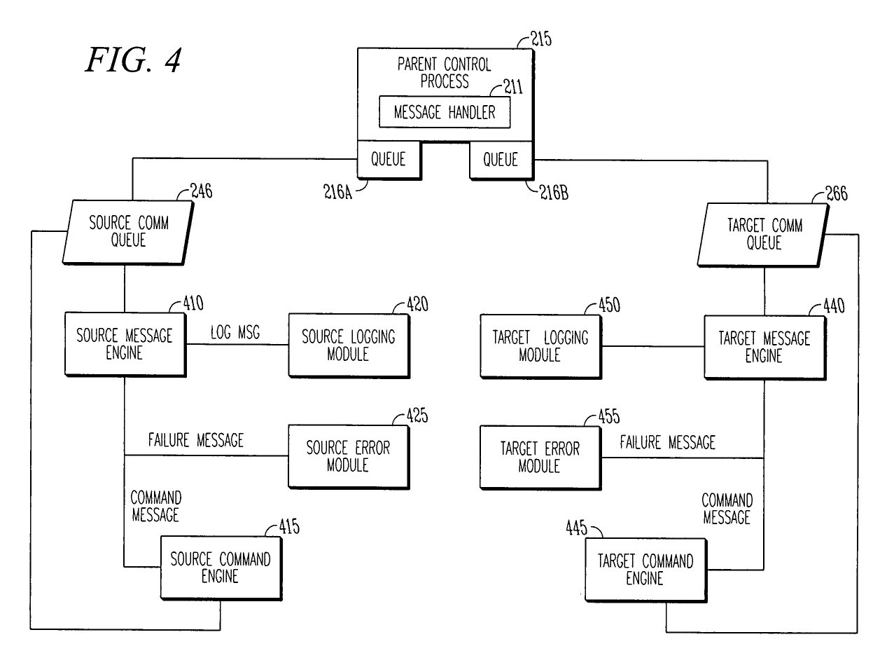

FIG. 4 illustrates in more detail a manner in which the control server 210 communicates with the source node 245 and target node 265 through the message handlers 211, 244 and 264, and the queues 216a, 216b, 246, and 266. As previously mentioned, the control process queue is multithreaded so that the control server 210 can independently deal with the source and target systems during startup and execution. As illustrated in FIG. 4, an instance of a parent control process 215 sends messages through message handler 211 and queues 216a and 216b to the source communications queue 246 and the target communications queue 266. These messages are received by the source message engine 410 and the target message engine 440 respectively. If the message is a command (such as for a source node 245 to begin transferring data to a target node 265, or for a target node 265 to respond to a polling status by the control server 210), the command is executed by the source command engine 415 or the target command engine 445 as the case may be. The source node 245 reports statuses back to the control server 210 through a source logging module 420, and further reports errors back to the control server 210 through an error module 425. Similarly, the target node 265 reports statuses back to the control server 210 through a target logging module 450, and further reports errors back to the control server 210 through a target error module 455.

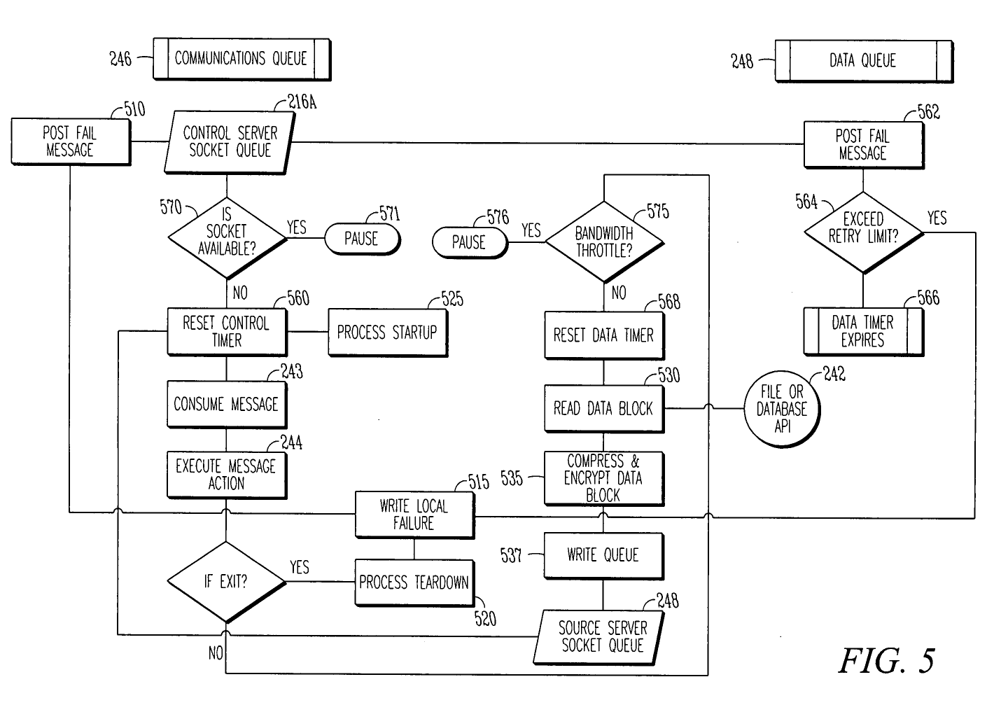

FIG. 5 illustrates an example embodiment of a process of implementing the communication socket queues of the control server 210 and the source node 245. FIG. 5 includes two halves, one for the communication queue 246 and the other for the data queue 248. A message enters the source node 245 from the control server socket queue 216a. If there is an error in sending/receiving this message at 510, an error message is written back to the control process at 515, and in serious circumstances, the control server 210 sends a message to the source node 245 to shutdown. Such a shutdown message would enter the source node 245 from the control server socket queue 216a, and execute the shutdown process at 520. If the message from the control server 210 to the source node 245 is a system startup message, the source node 245 is started up at 525. After the source node has successfully started up, and the control server 210 has confirmed that the paired target node 265 has also successfully started, a message is sent to the source node 245 to transfer data to the target node 265. Such a message originates from the control server socket queue 216a, is received at queue 246, and is processed by the message handler 244. After the message handler 244 determines that it is a command to begin to transfer data, the source DMU 247, through the utility programs 241, reads data at 530 from the database 242. After reading the data, the data may be compressed and/or encrypted at 535, and written to the source server socket data queue 248 at 537, thereby transferring the data through the data communication sockets 243. In an embodiment in which the data is compressed, the bandwidth of the system is more effectively utilized so as to not negatively impact other systems that share the resources of the network. The reset timer controls 560 and 568, the post fail message 562, the retry limit 564, and the data timer expires 566 implements a timing system that prevents the source process from exceeding a threshold. If the threshold is exceeded, the control server 210 may assume that there is a problem with the source node 246, and bring down the source node and its paired target node 265. If the checks of the socket at 570 and bandwidth throttle at 575 evoke a positive response, the process will pause at 571 and 576 respectively, and recheck the socket and bandwidth throttle at a later time.

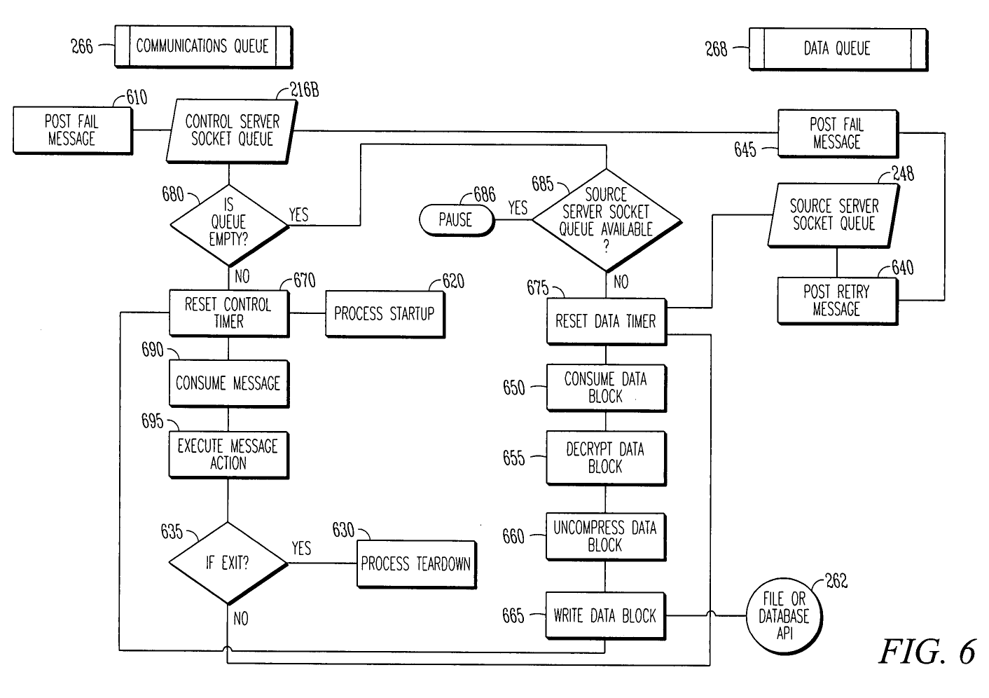

FIG. 6 illustrates an example embodiment of a process that implements the target communication queue 266 and the target data queue 268. FIG. 6 is divided into a first half representing the target communication queue 266 and a second half representing the target data communication queue 268. In the communication queue 266, a message is received from the control server 210 via the control server socket queue 216b. If there is a problem with the sending or receipt of this message, an error message is posted back to the control server 210 at 610. If the message from the control server 210 is a message to startup the target node 265, the process startup procedure at 620 is invoked. If the message from the control server 210 is a shutdown message to bring down the target node 265, a teardown process 630 is invoked. The message is received at 690 and executed at 695. If it is determined at decision block 635 that it is not a shutdown message, the target node 265 is instructed by the control server 210 to ready itself to receive data from its paired source node 245. Specifically, a message is received from the source server data socket queue 248. If there is a problem in the transfer, it is retried at 640, and if a problem remains, a fail message is posted at 645 to the control server socket queue 216b. Otherwise, the target node 265 receives the data coming in at 650, decrypts the incoming data at 655, uncompresses the data at 660, and writes the data to a file or database 262 at block 665. The reset control timer 670 and reset data timer 675 reset the respective timers as the target node 265 enters those sections of the code. If the check on the queue at 680 indicates that the queue is empty, the process will check the queue at 685. If the source server socket queue is available at 685, the process pauses at 681, and rechecks the queue after a certain period of time.

The instantiation and control of multiple source nodes 245 and multiple target nodes 265, each node with its own dedicated operating system and memory resources, in connection with the partitioning of data across these multiple instances of the server nodes and target nodes, and the compression of that data, provides a massively parallel processing environment that transfers the data from a source system 240 to a target system 260 without overburdening network resources. The exact architecture of a system 200 as illustrated in FIGS. 2a, 2b, and 2c, which is created either statically or dynamically at startup time depends upon several factors including the amount of data to be transferred from the source system to the target system, the type of that data, the efficiency of the compression algorithm, the architecture and availability of the processor(s) on which the source and target module execute, and the bandwidth available between the source system and the target system. With proper analysis of the system needs and proper setup, the parallel transfer of massive amounts of data can be accomplished without occupying inordinate amounts of processor time and/or taking up extensive bandwidth. That is, using an embodiment as disclosed herein, a source system 240 and a target system 260 can undertake a transfer of a massive amount of data, e.g. for backup purposes, without affecting the normal everyday operations of the source system, the target system, or the shared networking resources between the two systems.

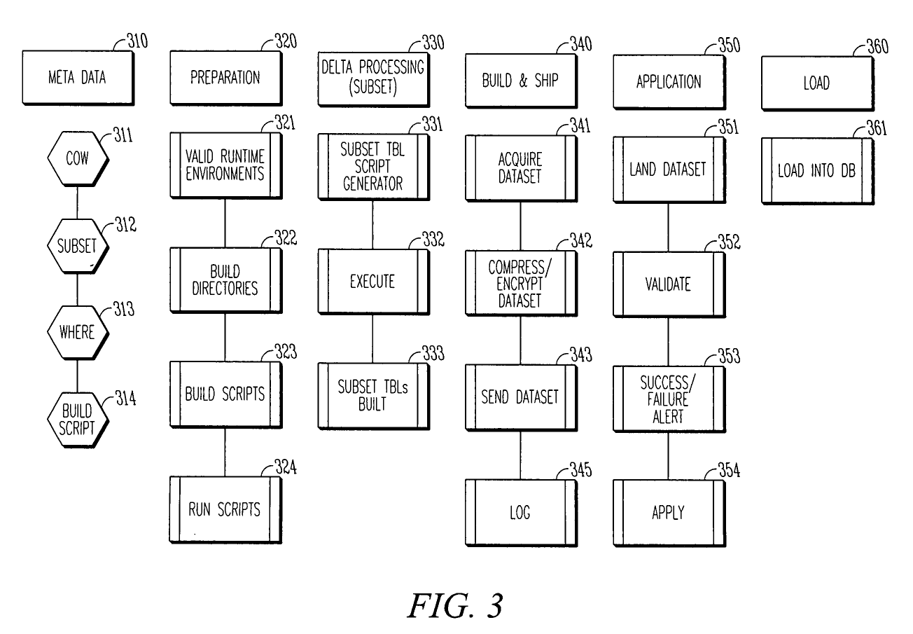

FIG. 3 illustrates in another manner an overview of an embodiment of a process that transfers data from a source system 240 to a target system 260. Specifically, FIG. 3 illustrates how such a process may be divided into a meta data phase 310, a preparation phase 320, a delta processing (or subset) phase 330, a build and ship phase 340, an application phase 350, and a load phase 360, 361.

In the meta data phase 310, a collection of work 311 is data that is to be analyzed to determine the portion thereof that is to be transferred from the source system 240 to the target system 260. For example, a particular data segment such as a data table may be small enough that the whole table can be transferred without an excessive strain on the system. In other cases, a subset 312 of this collection of work 311 may be created to decrease the amount of data that has to be transferred. In an embodiment, such a subset 312 may consist of only the records that have changed since the last transfer of data from the source system 240 to the target system 260. In an embodiment, the records to be transferred may be extracted with an SQL WHERE clause (block 313). A script is built at 314 that gathers environmental variables and sets up instances to execute.

In the preparation phase 320, runtime environments are built at 321 from the scripts generated at 314. Directories are built at 322 based on the subset 312. The directories are later used to locate the data that is to be transferred. The preparation phase is further used to build additional scripts at 323 based in part on the results of SQL WHERE operations. These scripts, when interpreted at 324, take part in four aspects of the data transfer process. First, scripts are constructed that generate the subset(s) of information tables. Second, scripts are generated that instruct the source DMU 247 and the target DMU 267 what to do. For example, a particular script may contain commands to instruct the source DMU 247 what tables or portions thereof to move from the source system 240 to the target system 260. In an embodiment, this involves invoking the utility programs 249, 269. Third, scripts are generated that validate all the data on the target system 260 that has been transferred there from the source system 240. Fourth, scripts are generated that are interpreted on the target system 260 and execute the apply function 350 on the target system. In particular, these scripts receive the data on the target system 260, and write the data to a clean database. Another script then will validate the transferred data, and if the data validates, the data will be written to the permanent database on the target system 260. The scripts also determine on the target system whether the data is a complete table, or just a portion of a larger table. If the data is a complete table, the target DMU 267 can overwrite the pertinent database on the target system. If it is only a portion of the database, the invocation of the scripts by the target DMU 267 will only change the records that have be transferred to the target system.

In the subset phase 330, scripts are generated at 331 to build subset tables that reflect the subsets 312 generated in the meta data phase 310. These scripts are executed at 332 resulting in tables being built at 333 that represent the subsets 312.

In the build and ship phase 340, the data to be transferred from the source system 240 to the target system 260 is acquired at 341 from the tables that were built at 333 using the scripts that were generated in the preparation phase 320. This data forms a dataset, which is read from the tables at 341. The dataset may then be compressed and/or encrypted at 342. Various compression lossless algorithms may be used such as gZip or zLib. After compression and encryption, the dataset is transferred at 343 to the target system 260, and a logging message is sent from the source system 240 to the control server 210 at 345.

In the apply phase 350 and load phase 360, the dataset first lands on the target system 260 at 351. Scripts generated in operation 320 are used at 352 to validate the data, and at 353 to determine if the transfer was successful or whether there was a problem in the transfer. The data is then applied at 354 to a clean database, validated, and loaded at 360, 361 to the permanent database 262.

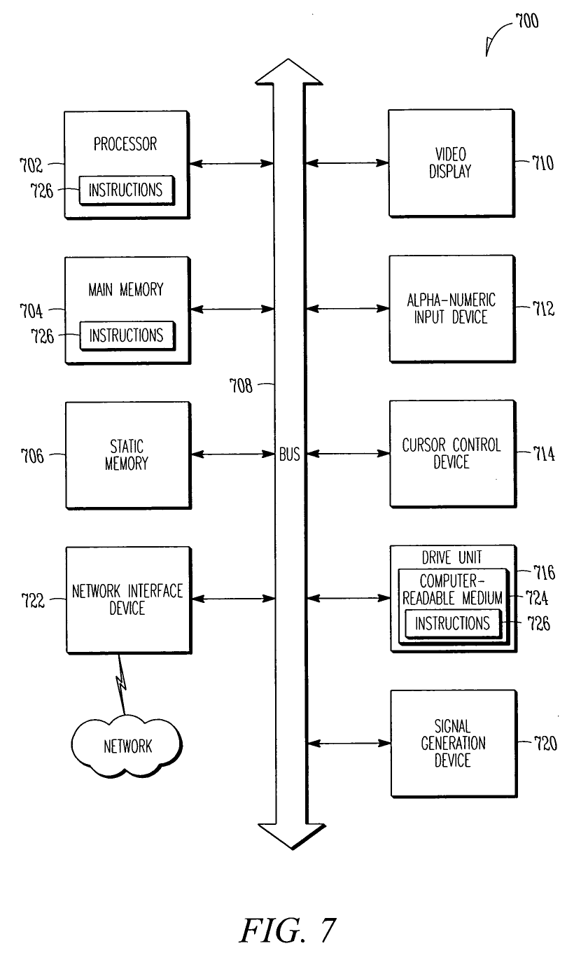

FIG. 7 shows a diagrammatic representation of machine in the exemplary form of a computer system 700 within which a set of instructions, for causing the machine to perform any one of the methodologies discussed above, may be executed. In the alternative embodiment, the machine may comprise a network router, a network switch, a network bridge, Personal Digital Assistant (PDA), a cellular telephone, a web appliance or any machine capable of executing a sequence of instructions that specify actions to be taken by the machine.

The computer system 700 includes a processor 702, a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alpha-numeric input device 712 (e.g., a keyboard), a cursor control device 714 (e.g., a mouse), a disk drive unit 716, a signal generation device 720 (e.g., a speaker) and a network interface device 722.

The disk drive unit 716 includes a computer-readable medium 724 on which is stored a set of instructions (i.e., software) 726 embodying any one, or all, of the methodologies described above. The software 726 is also shown to reside, completely or at least partially, within the main memory 704 and/or within the processor 702. The software 726 may further be transmitted or received via the network interface device 722. For the purposes of this specification, the term “computer-readable medium” shall be taken to include any medium that is capable of storing or encoding a sequence of instructions for execution by the computer and that cause the computer to perform any one of the methodologies of the present invention. The term “computer-readable medium” shall accordingly be taken to included, but not be limited to, solid-state memories, optical and magnetic disks, and carrier wave signals.

Thus, a method and apparatus for transferring data from a source system to a target system have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

1. A system comprising:
a control server;
a source system coupled to said control server;
a target system coupled to said control server;
a source system module in said source system; and
a target system module in said target system;
wherein said source system module is coupled to said target system module;
wherein said control server instantiates said source system module and said target system module; and
wherein said control server instructs said source system module to transfer data to said target system module.

2. The system of claim 1, further comprising:
a master controller server coupled to said control server; and
a global process file;
wherein said master controller server has access to said global process file.

3. The system of claim 1, wherein
said source system comprises a plurality of source nodes; and
said target system comprises a plurality of target nodes;
wherein said source nodes comprise one or more of said source system modules; and further
wherein said target nodes comprise one or more of said target system modules.

4. The system of claim 1, further comprising:
a source database;
a first target database; and
a second target database;
wherein said source system module is to transfer a portion of said source database to said first target database;
wherein said target system module is to write said portion of said source database to said first target database;
wherein said target system module further is to validate said portion of said source database on said first target database; and further
wherein said target system module is to write said portion of said source database to said second target database.

5. The system of claim 1, further comprising a process to receive specifications of resources for said system and to dynamically allocate said system resources.

6. The system of claim 3, wherein said control server is to instantiate and to control a plurality of said modules on said plurality of said source system nodes and a plurality of said modules on said plurality of said target system nodes.

7. The system of claim 3, wherein said plurality of modules on said plurality of source nodes and said plurality of modules on said plurality of target nodes reside on multiple images of an operating system.

8. The system of claim 1, further comprising:
one or more communication queues; and
one or more data queues;
wherein said one or more communications queue reside in said control server, said source system, and said target system; and further
wherein said one or more data queues reside in said source system and said target system.

9. The system of claim 1, further comprising:
a second target system coupled to said control server and said source system;
wherein said control server is to instantiate said second target system; and
wherein said control server is to instruct said source system to transfer data to said second target system.

10. The system of claim 8, further comprising a control server message handler, a source system message handler, and a target system message handler; and further wherein said one or more communication queues are multithreaded, and said one or more data queues are single threaded.

11. The system of claim 1, wherein said data is compressed and encrypted before said source system transmits said data to said target system.

12. The system of claim 2, wherein said global processing file comprises parameters for a location of said control server, a location of said source system, a location of said target system, and an allotted bandwidth on a network for said source and target systems.

13. The system of claim 3, wherein said data transfer involves said plurality of source nodes and said plurality of target nodes operating simultaneously in parallel.

14. The system according to claim 5, wherein said system resources comprise a location of said source system, a number of nodes in said source system, a location of said target system, a number of nodes in said target system, and an allotment of bandwidth for said source and target systems.

15. The system of claim 1, wherein
said control server is coupled to said source system via a first socket;
said control server is coupled to said target system via a second socket; and
said source system is coupled to said target system via a third socket.

16. A computer-implemented method comprising:
initiating a control process;
instantiating a source system and a target system with said control process;
sending a message from said control process to said source system and said target system, said message instructing said source system to transfer data to said target system; and
transmitting data from said source system to said target system.

17. The computer-implemented method of claim 16, wherein said control process instantiates one or more parent control processes, and further wherein each one of said parent control processes instantiates a source node and target node.

18. The computer-implemented method of claim 17, wherein a plurality of multiple parent control processes instantiate a plurality of source nodes and target nodes, and further wherein said plurality of source nodes transfers data to said plurality of target nodes simultaneously and in parallel.

19. The computer-implemented method of claim 16, further comprising statically setting a network bandwidth threshold for said data transfer.

20. The computer-implemented method of claim 16, further comprising dynamically setting a network bandwidth threshold for said data transfer.

21. The computer-implemented method of claim 18, wherein said control process informs a source node of the portion of a database to transfer to said target node.

22. The computer-implemented method of claim 16, further comprising dynamically determining the portion of a database that a source node transfers to a target node.

23. The computer-implemented method of claim 16, further comprising:
compressing and encrypting said data before said source system transmits said data to said target system.

24. A machine readable medium comprising instructions thereon for executing a process comprising:
initiating a control process;
instantiating a source system and a target system with said control process;
sending a message from said control process to said source system and said target system, said message instructing said source system to transfer data to said target system; and
transmitting data from said source system to said target system.

25. The machine readable medium of claim 24, wherein said control process instantiates one or more parent control processes, and further wherein each one of said parent control processes instantiates a source node and target node.

26. The machine readable medium of claim 25, wherein a plurality of multiple parent control processes instantiate a plurality of source nodes and target nodes, and further wherein said plurality of source nodes transfers data to said plurality of target nodes simultaneously and in parallel.

27. The machine readable medium of claim 24, further comprising dynamically determining an environment for the transmission of data from said source system to said target system.

28. The machine readable medium of claim 24, further comprising statically determining an environment for the transmission of data from said source system to said target system.

29. A computer-implemented method comprising:
determining data to be transferred from a first system to a second system;
generating a script to gather environmental variables and to set up instances to execute;
building runtime environments;
building directories based on said data;
generating a second script to generate subsets of information tables to inform a source system process and a target system process the functions to execute, to validate data that has been transferred to said second system, and to apply said data to said second system;
acquiring said data from a database in said first system, and transferring said data from said first system to said second system; and
writing said data to a database in said second system.

30. The computer-implemented method of claim 29, wherein
said first system comprises a plurality of nodes;
said second system comprise a plurality of nodes; and
said data is transferred simultaneously and in parallel from said first system to said second system using said plurality of first system nodes and said plurality of second system nodes.
